(19) United States
(12) Patent Application Publication
(10) Pub. No.: US 2008/0279591 A1
(43) Pub. Date: Nov. 13, 2008

(54) One-component toner and image forming method

(76) Inventors: Hideaki Yasunaga, Osaka (JP); Hiroaki Kato, Nagaokakyo-shi (JP); Kazuoki Fuwa, Osaka (JP); Masayuki Hagi, Osaka (JP); Yoshihiro Mikuriya, Nishinomiya-shi (JP); Takuya Kadota, Kobe-shi (JP); Hiroyuki Murakami, Osaka (JP); Yoshimichi Ishikawa, Itami-shi (JP); Katsunori Kurose, Takarazuka-shi (JP)

Correspondence Address: COOPER & DUNHAM, LLP, 1185 AVENUE OF THE AMERICAS, NEW YORK, NY, 10036, US

(21) Appl. No.: 11/895,303

(22) Filed: Aug. 23, 2007

(30) Foreign Application Priority Data
Sep. 4, 2006 (JP) 2006-238658

(51) Int. Cl. G03G 15/08; G03G 9/08

(52) U.S. Cl. 399/252; 430/108.6

(57) ABSTRACT

The present invention is to provide a nonmagnetic one-component toner containing a colorant, and a binder resin, wherein metal oxide fine particles are fixed on a toner surface with an adhesion strength of 95% to 99%, the toner has a direct current resistance of 1E7 Ω·cm to 1E9 Ω·cm, and an electrostatic capacity of 1.0E-12F to 1.5E-11F.

### BACKGROUND OF THE INVENTION

1. Field of the Invention

The present invention relates to a nonmagnetic one-component development toner for developing a latent electrostatic image, specifically, a toner suitable for an image forming apparatus having a developing unit which forms a thin layer of the toner by pressing a developing roller and a controlling blade and further having a fixing unit configured to fix a toner image to a recording medium by oilless fixing, and an image forming method using the toner.

Moreover, the present invention relates to a toner for electrostatic development used for copy machines and printers to which electrophotographic technology is applied, and an image forming method using the same. Specifically, it relates to a toner for electrostatic development, capable of suppressing fog on a paper sheet and uneven concentration of image caused by charge failure of the toner, and of obtaining excellent image stability, and to an image forming method using the toner.

2. Description of the Related Art

Conventionally in electrophotographic methods, a surface of a photoconductor (also referred as a latent electrostatic image bearing member) is charged and exposed to form a latent electrostatic image, the latent electrostatic image is developed by coloring toners to form a toner image, and the toner image is transferred onto a medium to be transferred such as transfer paper and fixed thereto with a heat roll to form an image.

Dry development systems employed in electrophotography and electrostatic recordings are of two types: a development system using a two-component developer composed of toner and carrier; and a development system using a one-component developer containing no carrier. The former development system can provide good images relatively stably, but does not lend itself to constant formation of images of the same quality over a long period of time, because the carrier is susceptible to degradation and the mixing ratio of toner and carrier varies easily, and there are also drawbacks such as difficulty in maintenance and downsizing of the apparatus. Thus, the latter development system using a one-component developer free from such drawbacks has been noticed.

This development system employs a process in which a toner (developer) is fed typically by at least one toner feeding unit, and a latent electrostatic image formed on a latent electrostatic image bearing member is visualized by the fed toner. In this process a controlling unit configured to control the toner layer thickness is faced to the toner feeding unit so as to charge the toner when the toner passes through the controlling unit. Various methods have been proposed for the controlling unit configured to control the toner layer thickness (a toner layer thickness control unit) facing the toner feeding unit, and one representative method controls the toner layer thickness by using a pressing unit (controlling blade), which is faced to the toner feeding unit so as to press the toner fed on the toner feeding unit surface with the controlling blade. Other methods are also available that are capable of obtaining the same effect by using a roller in place of a blade.

However, in the above charging method, only a fraction of toner particles is charged that has been frictionally contacted with the developing roller and thus the toner is not fully charged. The toner particles, which were not developed and passed through the controlling blade again, are relatively highly charged. Thus there has been a problem in the art that after this step has been repeated, the charge distribution becomes broad due to durability. Additionally, charge is rapidly injected when the once-developed toner is moved to a recording medium by electric field. Particularly, in the toner image formed at the beginning of full-color image formation, charge is injected to the toner many times. As a result, the toner charge distribution significantly varies in each color.

To solve these problems, various improvements of the electric properties of toner have been achieved as described hereinbelow.

Japanese Patent Application Laid-Open (JP-A) No. 1-116647 discloses a nonmagnetic one-component toner containing 0.05% to 2.0% of conductive metal oxides on the surface thereof, and having an electrostatic capacity of 6.0 pF to 11.0 pF. In Examples and the description of the specification, the method employed for attaching the conductive metal oxides on the toner surface is mixing, as with external addition. By this method, however, the conductive metal oxides are not firmly fixed to the toner base, thus fine particles of the conductive metal oxides less contribute to chargeability, and a desired effect of charge stability cannot be obtained. Additionally, an appropriate range of electric property of fine particles within which the charge of a one-component developer is stabilized is not defined in the specification. Therefore, an effect of the charge stability cannot be obtained as noted above.

In addition, the toner composition is different from that of the present invention. The present invention has been accomplished based on the premise that an external additive is substantially fixed on the toner. Thus, when the external additive is not fixed on the toner, the electric properties cannot be controlled.

Japanese Patent Application Laid-Open (JP-A) No. 5-158275 discloses that a toner is used for a toner-jet system, and metal oxides to be fixed are mechanically attached to the toner surface. The system adopted is different from that of the present invention, and the dispersion diameter and electric properties of fine particles for obtaining appropriate electric properties that contribute to charge stability are not defined. Therefore, any effect cannot be obtained only by fixation of metal oxide fine particles.

The toner composition in JP-A No. 5-158275 is prepared basically under the same idea as that of the present invention. However, the physical property and fixed state of metal oxides to be fixed are not defined. Thus, most of the metal oxides do not contribute to achieve a one-component toner.

Japanese Patent Application Laid-Open (JP-A) No. 3-77960 discloses a toner in which polyvinylidene-fluoride particles, conductive particles and charged fine particles are mechanically fixed on a toner surface. Appropriate electric properties of the toner and the dispersion diameter of the fixed fine particles to obtain charge stability in one-component development are not defined. Therefore, any effect cannot be obtained only by fixation of fine particles. In order to obtain charge stability, only semi-conductive fine particles having a defined resistance is needed. In this composition, the charge rise property is improved, but the charge cannot be kept well.

### BRIEF SUMMARY OF THE INVENTION

The present invention has been made for the purpose of solving the above problems in the prior art.

An object of the present invention is to provide a toner composition for electrostatic development used for copy machines and printers to which electrophotography is applied, and an image forming method using the toner, specifically, a nonmagnetic one-component toner composition for electrostatic development, which generates no background smear, and can obtain an excellent image performance by efficiently and uniformly conducting frictional charging between the developing roller and a controlling blade in a developing unit.

These problems are solved by the following <1> to <12> of the present invention.

<1> A nonmagnetic one-component toner containing a colorant, and a binder resin, wherein metal oxide fine particles are fixed on a toner surface with an adhesion strength of 95% to 99%, the toner has a direct current resistance of 1E7 Ω·cm to 1E9 Ω·cm, and an electrostatic capacity of 1.0E-12F to 1.5E-11F.

<2> The nonmagnetic one-component toner according to <1>, wherein the metal oxide fine particles have a specific resistance of 1.0E7 Ω·cm to 5.0E9 Ω·cm.

<3> The nonmagnetic one-component toner according to <1>, wherein the metal oxide fine particles fixed on the toner surface are titanium oxide, and the metal oxide fine particles have dispersion diameter of 10 nm to 50 nm, and the content of the metal oxide fine particles is 1.0% by mass to 2.0% by mass based on the toner mass.

<4> The nonmagnetic one-component toner according to <1>, wherein the toner has a volume average particle diameter of 6 μm to 10 μm.

<5> The nonmagnetic one-component toner according to <1>, wherein the toner has an average circularity of 0.900 to 0.930.

<6> An image forming apparatus containing a plurality of developing units configured to form a color image by using black and color nonmagnetic toners, wherein the developing unit contains a controlling blade applied with a negative bias with respect to a developing roller, wherein the toner is a nonmagnetic one-component toner containing a colorant, and a binder resin, wherein metal oxide fine particles are fixed on a toner surface with an adhesion strength of 95% to 99%, the toner has a direct current resistance of 1E7 Ω·cm to 1E9 Ω·cm, and an electrostatic capacity of 1.0E-12F to 1.5E-11F.

<7> The image forming apparatus according to <6>, wherein an absolute value of the potential difference between the developing roller and the controlling blade is 50 V to 200 V.

<8> The image forming apparatus according to <6>, further including a fixing unit configured to fix a toner image to a recording medium by oilless fixing, wherein the content of a releasing agent in the toner is 3.0% by mass to 5.0% by mass.

<9> A process cartridge containing a latent electrostatic image bearing member configured to bear a latent electrostatic image, a developing unit configured to develop the latent electrostatic image borne on the latent electrostatic image bearing member by using a toner so as to form a visible image, and contains a controlling blade applied with a negative bias with respect to a developing roller, wherein the process cartridge is mounted to an image forming apparatus, and the image forming apparatus containing a plurality of the developing units configured to form a color image by using black and color nonmagnetic toners, wherein the toner is a nonmagnetic one-component toner containing a colorant, and a binder resin, wherein metal oxide fine particles are fixed on a toner surface with an adhesion strength of 95% to 99%, the toner has a direct current resistance of 1E7 Ω·cm to 1E9 Ω·cm, and an electrostatic capacity of 1.0E-12F to 1.5E-11F.

<10> An image forming method including forming a color image by using a plurality of developing units containing black and color nonmagnetic toners, wherein the developing unit containing a controlling blade applied with a negative bias with respect to a developing roller, wherein the toner is a nonmagnetic one-component toner containing a colorant, and a binder resin, wherein metal oxide fine particles are fixed on a toner surface with an adhesion strength of 95% to 99%, and the toner has a direct current resistance of 1E7 Ω·cm to 1E9 Ω·cm, and an electrostatic capacity of 1.0E-12F to 1.5E-11F.

<11> The image forming method according to <10>, wherein an absolute value of the potential difference between the developing roller and the controlling blade is 50 V to 200 V.

<12> The image forming method according to <10>, further including a fixing a toner image to a recording medium by oilless fixing, wherein the content of a releasing agent in the toner is 3.0% by mass to 5.0% by mass.

In the image forming apparatus, the nonmagnetic one-component toner according to <1> is charged by both charge injection from the controlling blade and contact frictional charge with the developing roller, and then the charge of the nonmagnetic one-component toner immediately rises to a desired charge level, and the electric capacity is not large. Since the toner does not have a large electric capacity, any additional charge injection in various processes does not occur and a stable charge property is exhibited. Thus, no image noise due to charging failure occur by using the toner.

The nonmagnetic one-component toner according to <2>, the resistance of the metal oxide fine particles fixed on the toner surface is defined. The toner resistance is not largely decreased and the toner has an optimal resistance to which charge is easily injected. Consequently, the charge stability is further improved.

The nonmagnetic one-component toner according to <3>, charged parts by charge injection and charged parts by frictional charge are alternately distributed, thereby obtaining the stable charge property.

In the image forming apparatus according to <6>, both charge injection from the controlling blade and contact frictional charge with the developing roller bring to immediate rise to a desired charge level, and the electric capacity is not large. Any additional charge injection in various processes does not occur and stable charge properties are exhibited, thus no image noises due to charging failure occur.

In the image forming apparatus according to <7>, the charging efficiency is good since charges can be injected in a moment.

In the image forming apparatus according to <8>, an oilless pulverized toner which is difficult to be uniformly charged in one-component development system is used. However, even such a system is very effective in charging stability by combining the frictional charge and charge injection.

### BRIEF DESCRIPTION OF THE SEVERAL VIEWS OF THE DRAWINGS

FIG. 1 shows a schematic view of an example of a pulverizing device.

FIGS. 2 A and 2B show schematic views of an Ong mill used for fixing fine particles on a toner surface.

FIG. 3 shows a conceptual diagram illustrating the relation between toner resistance and electrostatic capacity.

FIG. 4 shows an example of an entire configuration of an image forming apparatus of the present invention.

FIG. 5 shows cross-sectional views of an example of a developing unit and process cartridge unit according to an embodiment of the present invention.

### DETAILED DESCRIPTION OF THE INVENTION

The toner particles of the present invention for forming a full-color image contain metal oxide fine particles fixed on a toner surface with adhesion strength of 95% to 99%, and the toner has a direct current resistance of 1E7 Ω·cm to 1E9 Ω·cm, and electrostatic capacity of 1.0E-12F to 1.5E-11F.

When the resistance component is less than 1E7 Ω·cm, the toner becomes conductive, and the charge storing ability may be significantly poor. When the resistance component is more than 1E9 Ω·cm, the charge rise property of the toner may be lowered, making the toner less amenable to one-component development systems. Moreover, when the electrostatic capacity is less than 1.0E-12F, the toner may have less charge storing ability and low saturated charge level, thus poorly-charged toner particles that lead to fog or the like increase. When the electrostatic capacity is more than 1.5E-11F, charges are injected in various electrophotographic processes, and the charge distribution may significantly vary in each color.

FIG. 3 shows a conceptual diagram illustrating a relation between a toner resistance and an electrostatic capacity in an easy-to-understand way. In FIG. 3, in area (i), the toner having a resistance of 1E7 Ω·cm or less becomes completely conductive, and the charge storing ability is significantly poor. In area (ii), the toner has an electrostatic capacity of 1.0E-12F or less, the charge storage ability is significantly poor, a saturated charge level is remarkably decreased. Area (iii) does not fall under the present invention. In area (iv), the charge rise property of the toner may be improved, but the toner is hard to be used due to a larger saturated charge level, and the charge level a little largely varies via an electrophotographic process. In area (v), the toner has a large resistance and the charge rise property may be insufficient, thus, the charge level significantly varies.

In the present invention, the electrostatic capacity of the toner “1.0E-12F to 1.5E-11F” is an electric capacity as measured when the toner pellet has a diameter of 40 mm and the toner amount is 3.0 g, which is described hereinafter as a production condition of the pellet in Evaluation of Electric Property.

The metal oxides to be fixed on the toner surface have a specific resistance of 1.0E7 Ω·cm to 5.0E9 Ω·cm. Too small resistance leads to a smaller toner resistance, and the saturated charge level becomes smaller, while an excess resistance makes fixing of metal oxide on the toner surface meaningless.

Therefore, there are optimal areas of electrostatic capacity and resistance, where it is ensured that charges are risen to a level desirable for one-component development in an instant when toner particles pass through a regulation unit and that the charge level is maintained.

The present invention relates to a toner composition that enables contact frictional charging and charge-injection charging at the same time in one-component charging.

### <Adjustment of Resistance and Electrostatic Capacity>

The adjustment of the resistance and the electrostatic capacity depends largely on the physical properties and the fixed state of metal oxides.

When low resistance metal oxides are fixed on the toner surface, the resistance and electrostatic capacity of toner may be largely decreased. On the other hand, when a high resistance metal oxide such as silica is fixed on the toner surface, the resistance and electrostatic capacity of toner may be kept large. The apparent toner resistance can be adjusted by adjusting the amount of metal oxide to be fixed, but the electrostatic capacity cannot be adjusted at the same time. The same is true for high resistance metal oxides.

When a metal oxide is internally added, the toner resistance may not be decreased but the electrostatic capacity may be decreased. The same is true in a case where a metal oxide is embedded in the toner due to too large fixation degree. When the fixation degree is weak, both the resistance and electrostatic capacity of toner may not be decreased. An optimal toner resistance and an optimal electrostatic capacity can be obtained only when a metal oxide having desired electric properties is properly fixed on the toner surface.

When desired values of the resistance and electrostatic capacity of the toner base are not obtained, they are adjusted by the amount of the metal oxides. However, the electric properties of the toner of the present invention are dominantly governed by the electric properties and fixed state of the metal oxide fixed on the toner surface. Thus, only a trace amount of metal oxide is used to adjust the resistance and electrostatic capacity of the toner base.

The toner base which can be used in the present invention generally contains a binder resin, a colorant and other additive(s).

Examples of the toner base include (1) a toner base obtained by melting and mixing together a colorant, a charge controlling agent, a releasing agent and the like such that they are uniformly dispersed in a thermoplastic resin to be a binder resin component to make a composition and subsequently pulverizing and classifying the composition, (2) a toner base obtained by dissolving or suspending a colorant, a charge controlling agent, a releasing agent and the like in a polymerizable monomer which is a binder resin raw material, adding a polymerization initiator, then dispersing the resultant mixture in a water-based medium containing a dispersion stabilizer, raising the medium temperature up to a predetermined level to initiate polymerization, followed by filtration, washing, dehydrating and drying, (3) a toner base obtained by allowing primary particles of polar group-containing binder resin obtained by emulsification polymerization to aggregate by the addition of a colorant and a charge controlling agent to make secondary particles, associating the secondary particles by stirring at a temperature higher than the glass transition temperature of the binder resin, and filtrating and drying the associated particles, and (4) a toner base prepared by phase change emulsification that includes the steps of adding a colorant and the like to a hydrophilic group-containing resin as a binder resin, dissolving the resin into an organic solvent, and allowing the resin to undergo phase change by neutralization followed by drying to yield colored particles. Any of these toner bases can be used.

The present invention will be described by way of a pulverized toner, but the present invention is not limited thereto.

### <Binder Resin>

Types of the binder resin are not particularly limited, and may be the binder resins known in the full color toner field. Examples thereof include polyester resins, (meth)acrylic resins, styrene-(meth)acryl copolymer resins, epoxy resins, and COC (cyclic olefin resins, for example, TOPAS-COC manufactured by Ticona). It is preferable to use the polyester resin in terms of stress resistance in the developing unit.

The polyester resin which is obtained through polycondensation of a polyvalent alcohol component and a polyvalent carboxylic acid component may be preferably used.

Examples of bivalent alcohol components as the polyvalent alcohol component include bisphenol A-alkylene oxide adducts such as polyoxypropylene (2,2)-2,2-bis(4-hydroxyphenyl)propane, polyoxypropylene (3,3)-2,2-bis(4-hydroxyphenyl)propane, polyoxypropylene (6)-2,2-bis(4-hydroxyphenyl)propane and polyoxyethylene (2,0)-2,2-bis(4-hydroxyphenyl)propane; ethylene glycol, diethylene glycol, triethylene glycol, 1,2-propylene glycol, 1,3-propylene glycol, 1,4-butandiol, neopentyl glycol, 1,4-butendiol, 1,5-pentanediol, 1,6-hexanediol, 1,4-cyclohexanedimethanol, dipropylene glycol, polyethylene glycol, polytetramethylene glycol, bisphenol A and hydrogenated bisphenol A.

Examples of trivalent or more alcohol components include sorbitol, 1,2,3,6-hexanetetrol, 1,4-sorbitan, pentaerythritol, dipentaerythritol, tripentaerythritol, 1,2,4-butantriol, 1,2,5-pentantriol, glycerol, 2-methylpropanetriol, 2-methyl-1,2,4-butantriol, trimethyrolethane, trimethyrolpropane, and 1,3,5-trihydroxymethylbenzene.

Furthermore, examples of bivalent carboxylic acid components of polyvalent carboxylic acid components include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenyl succinic acid, isododecenyl succinic acid, n-dodecyl succinic acid, isododecyl succinic acid, n-octenyl succinic acid, isooctenyl succinic acid, n-octyl succinic acid, isooctyl succinic acid and anhydrides thereof or lower alkylester.

Examples of trivalent or more carboxylic acid components include 1,2,4-benzenetricarboxylic acid (trimellitic acid), 1,2,5-benzentricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, enpol trimeric acid and anhydrides thereof or lower alkylester.

Furthermore, a resin obtained by performing condensation polymerization for obtaining polyester resin and radical polymerization for obtaining vinyl resin simultaneously in a same container using a mixture of a basic monomer of polyester resin, basic monomer of vinyl resin and a monomer which reacts with the basic monomers of both resins may be also preferably used as the polyester resin (hereinafter, referred to as “vinyl-based polyester resin”). Meanwhile, a monomer which reacts with basic monomers of both resins is defined as a monomer which can be used for both reactions of condensation polymerization and radical polymerization. In other words, it is a monomer having a carboxyl group which is reactable in condensation polymerization and a vinyl group which is reactable in radical polymerization and examples of such monomer include fumaric acid, maleic acid, acrylic acid and methacrylic acid.

Examples of the basic monomers of the polyester resin include the above-described polyvalent alcohol components and polyvalent carboxylic components. Examples of the basic monomers of the vinyl based resin include styrene or styrene derivatives such as styrene, o-methylstyrene, m-methylstyrene, p-methylstyrene, α-methylstyrene, p-ethylstyrene, 2,4-dimethylstyrene, p-tert-butylstyrene and p-chlorostyrene; unsaturated monoolefins such as ethylene, propylene, butylene and isobutylene; methacrylate alkyl esters such as methyl methacrylate, n-propyl methacrylate, isopropyl methacrylate, n-butyl methacrylate, isobutyl methacrylate, t-butyl methacrylate, n-pentyl methacrylate, isopentyl methacrylate, neopentyl methacrylate, 3-(methyl)butyl methacrylate, hexyl methacrylate, octyl methacrylate, nonyl methacrylate, decyl methacrylate, undecyl methacrylate and dodecyl methacrylate; acrylate alkyl esters such as methyl acrylate, n-propyl acrylate, isopropyl acrylate, n-butyl acrylate, isobutyl acrylate, t-butyl acrylate, n-pentyl acrylate, isopentyl acrylate, neopentyl acrylate, 3-(methyl)butyl acrylate, hexyl acrylate, octyl acrylate, nonyl acrylate, decyl acrylate, undecyl acrylate and dodecyl acrylate; unsaturated carboxylic acids such as acrylic acid, methacrylic acid, itaconic acid and maleic acid; acrylonitrile, maleate ester, itaconate ester, vinyl chloride, vinyl acetate, vinyl benzoate, vinyl methyl ethyl ketone, vinyl hexyl ketone, vinyl methyl ether, vinyl ethyl ether and vinyl isobutyl ether. Examples of the polymerization initiators when the basic monomer of the vinyl based resin is polymerized include azo based or diazo based polymerization initiators such as 2,2′-azobis(2,4-dimethylvaleronitrile), 2,2′-azobisisobutylonitrile, 1,1-azobis(cyclohexane-1-carbonitrile) and 2,2′-azobis-4-methoxy-2,4-dimethylvaleronitrile; and peroxide based polymerization initiators such as benzoyl peroxide, dicumyl peroxide, methyl ethyl ketone peroxide, isopropyl peroxycarbonate and lauroyl peroxide.

As the binder resin, the above-described various polyester based resins are preferably used. Of these, it is effective and more preferable to combine a first binder resin and a second binder resin as described hereinafter, in terms of enhancing the separation property and the offset resistance as the toner for oilless fixing.

That is, as the first binder resin, the polyester resins obtained by polycondensing the above-described polyvalent alcohol component and polyvalent carboxylic acid component, particularly, the polyester resins obtained by using a bisphenol A alkylene oxide adduct as the polyvalent alcohol component and using terephthalic acid and fumaric acid as the polyvalent carboxylic acids are used.

As the second binder resin, the vinyl-based polyester resins, particularly the vinyl-based polyester resins obtained by using a bisphenol A alkylene oxide adduct, terephthalic acid, trimellitic acid and succinic acid as the basic monomers of the polyester resin, using styrene and butyl acrylate as the basic monomers of the vinyl based resin and using fumaric acid as the monomer which reacts with the both are used.

In the present invention, a hydrocarbon-based wax is preferably internally added upon synthesis of the first binder resin. To previously internally add the hydrocarbon-based wax to the first binder resin, the first binder resin may be synthesized with adding the hydrocarbon-based wax in the monomers for synthesizing the first binder resin. For example, the polycondensation may be performed in a state that the hydrocarbon-based wax has been added to an acid monomer or alcohol monomer which composes the polyester-based resin as the first binder resin. When the first binder resin is a vinyl-based polyester resin, a hydrocarbon-based wax is first added to a monomer for polyester resin, and then polycondensation and radical polymerization may be performed by adding dropwise a basic monomer for the vinyl-based resin to the monomer while stirring and heating the monomers.

### <Wax>

Generally, a wax having a lower polarity is more excellent in the separation property from the fixing unit roller. The wax used as the releasing agent in the present invention is a hydrocarbon-based wax having a low polarity.

### <Hydrocarbon-Based Wax>

The hydrocarbon-based wax is the wax composed of only carbon atoms and hydrogen atoms, and the wax not containing ester, alcohol and amide groups. Examples of the hydrocarbon-based waxes include polyolefin waxes such as polyethylene, polypropylene and copolymers of propylene with ethylene; petroleum waxes such as paraffin wax and microcrystalline wax; and synthetic waxes such as Fisher Tropsch wax. Of these, the polyethylene wax, the paraffin wax and the Fisher Tropsch wax are preferable, and the polyethylene wax and the paraffin wax are more preferable.

### <Melting Point of Wax>

The melting point of the wax is represented by an endothermic peak of the wax upon temperature rising measured by a differential scanning calorimeter (DSC), and is preferably 70° C. to 90° C. When the melting point exceeds 90° C., melt of the wax in a fixing process becomes insufficient and the separation property from the fixing unit may not be assured sometimes. When it is lower than 70° C., the toner particles are fused and bonded one another under the high temperature and high humidity environment, causing a problem in storage stability. To allow for the separation property at low temperature, the melting point of the wax is more preferably 70° C. to 85° C. and still more preferably 70° C. to 80° C.

### <Endothermic Peak of Wax>

A half value width of the endothermic peak of the wax upon temperature rising measured by the differential scanning calorimeter (DSC) is preferably 7° C. or less. Since the melting point of the above wax is relatively low, the wax having the broad endothermic peak, i.e., which melts at low temperature adversely affects the storage stability of the toner.

### <Content of Wax>

A content of the wax in the toner of the present invention is preferably 3% by mass to 10% by mass, more preferably 4% by mass to 8% by mass and still more preferably 4% by mass to 6.5% by mass. When the content of the wax is less than 3% by mass, the amount of the wax permeated between the melted toner and the fixing unit in the fixing process is insufficient. Since the adhesive force between the melted toner and the fixing unit is not reduced, the recording medium is not separated from the fixing unit. Meanwhile, when the content of the wax exceeds 10% by mass, the amount of the wax exposed on the toner surface is increased and the fluidity of the toner may be decreased. Thus, transfer efficiency from a developing unit to the photoconductor and from the photoconductor to the recording medium is reduced, and then not only the image quality is significantly reduced, but also the wax is released from the toner surface and contamination of the developing unit and photoconductor may be caused.

### <Content Ratio of First Binder Resin and Second Binder Resin>

A content ratio of the first binder resin (including the amount of the internally added wax) to the second binder resin in the toner particle is preferably 20/80 to 45/55 and more preferably 30/70 to 40/60 by mass ratio. When the amount of the first binder resin is too small, the separation property and the high temperature offset resistance may be poor. When the amount of the first binder resin is too large, glossiness and heat resistant storage stability may be poor.

More preferably, a softening point of the binder resin composed of the first binder resin and the second binder resin used at the above mass ratio is preferably 100° C. to 125° C. and particularly preferably 105° C. to 125° C. In the present invention, the softening point of the binder resin composed of the first binder resin in which the wax is internally added and the second binder resin may be within the above range.

An acid value of the first binder resin in which the wax is internally added is preferably 5 KOH mg/g to 50 KOH mg/g and more preferably 10 KOH mg/g to 40 KOH mg/g. The acid value of the second binder resin is preferably 0 KOH mg/g to 10 KOH mg/g and more preferably 1 KOH mg/g to 5 KOH mg/g. In particular, when the polyester resin is used, by using the resin having such acid value, it is possible to enhance dispersibility of various colorants and to make the toner having sufficient charge amount. The first binder resin preferably contains the component which is insoluble in tetrahydrofuran (THF) in terms of the high temperature offset resistance. The content of the component insoluble in THF in the first binder resin in which the wax is internally added is preferably 0.1 parts by mass to 15 parts by mass, more preferably 0.2 parts by mass to 10 parts by mass and particularly preferably 0.3 parts by mass and 5 parts by mass.

### <Colorant>

As the colorant used in the present invention, the known pigments and dyes conventionally used as the colorants for full color toners can be used. Examples thereof include carbon black, aniline blue, calcoil blue, chromium yellow, ultramarine blue, DuPont oil red, quinoline yellow, methylene blue chloride, copper phthalocyanine, malachite green oxalate, lamp black, rose Bengal, C.I. pigment red 48:1, C.I. pigment red 122, C.I. pigment red 57:1, C.I. pigment red 184, C.I. pigment yellow 97, C.I. pigment yellow 12, C.I. pigment yellow 17, C.I. pigment yellow 74, C.I. solvent yellow 162, C.I. pigment yellow 180, C.I. pigment yellow 185, C.I. pigment blue 15:1 and C.I. pigment blue 15:3. The content of the colorant in the toner particles is preferably 2 parts by mass to 15 parts by mass relative to 100 parts by mass of the total binder resins. The colorant is preferably used in a form of the master batch in which the colorant is dispersed in the mixed binder resin of the first and second binder resins, in terms of dispersibility. The amount of the master batch to be added may be any as long as the amount of the colorant is in the above range. It is suitable that a content ratio of the colorant in the master batch is 20 parts by mass to 40 parts by mass.

### <Charge Controlling Agent>

In the toner of the present invention, known charge controlling agents conventionally used for the full color toner may be used.

Examples thereof include nigrosine dyes, triphenylmethane dyes, chromium-containing metal complex dyes, molybdic acid chelate pigments, rhodamine-based dyes, alkoxy-based amine, quaternary ammonium salts (including fluorine modified quaternary ammonium salts), alkylamide, a single body or compounds of phosphorus, a single body or compounds of tungsten, fluorine-based active agents, salicylate metal salts and metal salts of salicylic acid derivatives. Specific examples include Bontron 03 of the nigrosine dye, Bontron P-51 of the quaternary ammonium salt, Bontron S-34 of the metal-containing azo dye, E-82 of oxynaphthoic acid-based metal complex, E-84 of salicylic acid-based metal complexes, E-89 of phenol-based condensate (manufactured by Orient Chemical Industries Ltd.); TP-302 and TP-415 of a quaternary ammonium salt molybdenum complexes (manufactured by Hodogaya Chemical Co., Ltd.); Copy Charge PSY VP2038 of the quaternary ammonium salts, Copy Blue PR of the triphenylmethane derivative, Copy Charge NEG VP2036 and Copy Charge NX VP434 of the quaternary ammonium salts (manufactured by Hoechst); LRA-901, and LR-147 of a boron metal complex (manufactured by Japan Carlit Co., Ltd.); copper phthalocyanine, perylene, quinacridone, azo-based pigments, and polymer-based compounds having functional groups such as sulfonic acid group, carboxyl group and quaternary ammonium salt. Of these, particularly, substances which control the toner to negative polarity are preferably used.

The amount of the charge controlling agent to be used is determined depending on the type of the binder resin, the presence or absence of additives used as needed and the method for producing the toner including a dispersion method, and is not uniquely limited, but is preferably 0.1 parts by mass to 10 parts by mass and more preferably 0.2 parts by mass to 5 parts by mass relative to 100 parts by mass of the binder resin. When the amount of the charge controlling agent exceeds 10 parts by mass, the toner is excessively charged, the effect of the charge controlling agent is reduced, and an electrostatic suction force to a developing roller is increased, leading to the reduction of the fluidity of the developer and the reduction of the image density.

### <External Additive>

Examples of inorganic fine particles used as external additives include silicon oxide, zinc oxide, tin oxide, silica sand, titanium oxide, clay, mica, wollastonite, diatom earth, chrome oxide, cerium oxide, colcothar, antimony trioxide, magnesium oxide, aluminum oxide, zirconium oxide, barium sulfate, barium carbonate, calcium carbonate, silicon carbide and silicon nitride.

The total amount of the external additives in the toner of the present invention is preferably 1.0 part by mass to 5.0 parts by mass relative to 100 parts by mass of the toner base. When the total amount of the external additives is larger than the above range, fog may occur and the developing property and the separation property may be adversely affected. When it is smaller than the above range, the fluidity, the transfer property and the heat resistant storage stability may be adversely affected.

### <Toner Production Method>

The toner of the present invention can be obtained by mixing and kneading together a first binder resin having a hydrocarbon-based wax internally added, a second binder resin and a colorant with a conventional method, pulverizing and classifying the kneaded product with conventional methods to obtain toner particles (colored resin particles) having a desired particle diameter, mechanically fixing a metal oxide to the surface of the toner base, and mixing an external additive therewith. The toner particle has an average particle diameter of 6 μm to 10 μm.

### <Pulverization Method>

A surfusion system (manufactured by Nippon Pneumatic Mfg. Co., Ltd.) is illustrated as an example of a pulverization method.

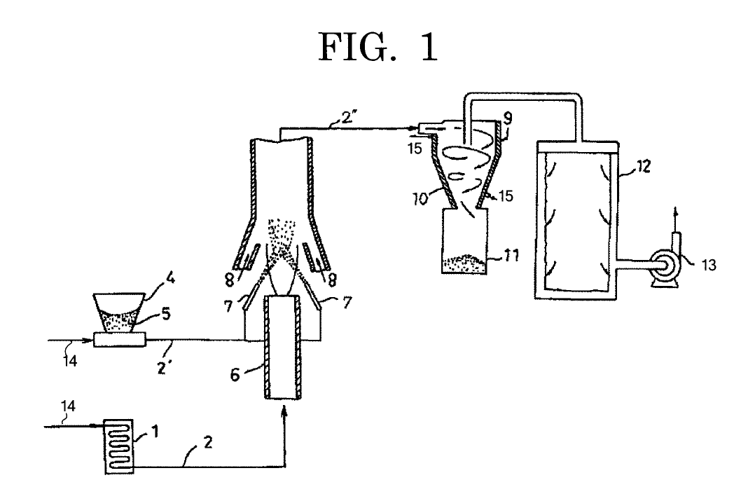

In FIG. 1, high-temperature, high-pressure air generated in a hot-air generating device 1 passes through an introduction pipe 2, and is injected from a hot-air jet nozzle 6. On the other hand, the toner is fed through an introduction pipe 2′ by a certain amount of pressurized air 14 from a quantitative supplier 4, and injected from a sample jet nozzle 7 disposed around the hot-air jet nozzle 6 into a thermal current. In this case, the sample jet nozzle 7 is preferably tilted at a certain degree relative to the hot-air jet nozzle 6, in order that a blowout flow from the sample jet nozzle 7 may not across the thermal current. The number of the sample jet nozzle 7 may be one or plural. However, plural, preferably two to three sample jet nozzles, which oppose each other and are tilted at a certain degree, are disposed in order to improve dispersibility of the sample in the thermal current. When plural sample jet nozzles are used, the toner is ejected at the certain degree from each sample jet nozzle to the center of the thermal current, so that the toner particles clash each other with appropriate force so as to be dispersed in the thermal current. Each of the toner particles is preferably homogeneously heated. The ejected toner particles are homogeneously heated by instantaneously being contacted with high-temperature hot air. Next, the heated toner particles are rapidly cooled by cold air introduced from a cool-air introduction part 8. As a result, adhesion to a wall of the device and aggregation of the toner particles are not caused, and yield is improved. Next, the toner particles are collected in a cyclone 9 through an introduction pipe 2″, and stored in a product tank 11. After the toner particles are collected, feed air passes through a bag filter 12 so as to remove fine particles, and passes through a blower 13 to be released to atmosphere. A cooling jacket 10 is equipped in the cyclone 9 to cool the toner particles by cool water 15 to prevent the aggregation of the toner particles in the cyclone.

### Treatment Condition

Hot air temperature: 200° C.

Feed air: 8 nl/h

Hot air: 0.3 Nm³/min

### <Method for Fixing Fine Particles on the Toner Surface>

The fine particles are fixed to the toner base by mechanofusion system. Any mechanofusion system may be used, as long as the system is configured to mechanically firmly fix the fine particles to the toner base, for example, a hybridization system manufactured by NARA MACHINERY Co, Ltd., is used.

The Ong mill will be schematically illustrated hereinbelow.

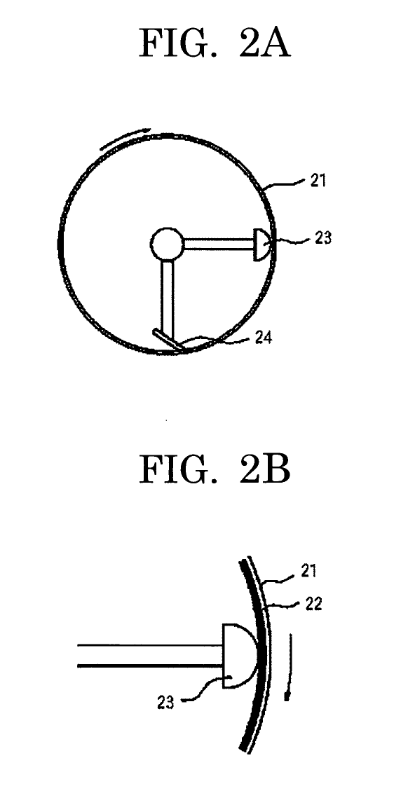

In FIGS. 2A and 2B, a casing 21 is rapidly rotated, and toner particles 22 in the casing 21 are pushed to an inner wall of the casing 21 by centrifugal force. As shown in FIG. 2B, the pushed toner particles 22 are brought to pass through between a meniscus 23 and the inner wall of the casing 21 where it is slightly narrower than a layer of the toner particles 22, and the resin on the surface of the toner particles 22 is melted to fix fine particles on the surface of the toner particles 22 by frictional heat caused by pushing force when the toner particles 22 pass therethrough. The toner particles 22 having fine particles fixed on the surface thereof are scraped out from the inner wall of the casing 21 by a scraping-out unit 24. In this example, the rotation of the casing 21 is adjusted to be at the frictional heat of approximately 40° C. by the pushing force when the toner particles 22 pass though between the meniscus 23 and the inner wall of the casing 21, and 200 g of the toner particles 22 is treated for 10 minutes. The casing has an outer diameter of 300 mm and a height of 80 mm.

A treatment temperature is preferably generated by a thermomechanical impact that produces temperatures around the glass transition point Tg of the toner, Tg±10° C., in view of preventing toner aggregation and productivity. More preferably, treatment is performed within ±5° C. of the glass transition point Tg of the toner.

### <Average Circularity of Toner Particles>

For the toner of the present invention, the toner particles preferably have an average circularity of 0.900 to 0.930.

The average circularity of the toner particles can be determined by a flow type particle image analyzer FPIA-2100 (by Sysmex Corporation) and analysis software (FPIA-2100 Data Processing Program for FPIA version 00-10). Specifically, 0.1 ml to 0.5 ml of a 10% by mass. surfactant (alkylbenzene sulfonate salt, Neogem SC-A manufactured by Dai-ichi Kogyo Seiyaku Co., Ltd.), and 0.1 g to 0.5 g of each toner are placed in a 100 ml glass beaker, stirred with a microspatel (microspatula), and then 80 ml of ion exchange water is added therein. The obtained dispersion is dispersed by an ultrasonic disperser (manufactured by Honda Electronics Co., Ltd.) for 3 minutes. The dispersion is subjected to dispersion treatment until the dispersion concentration becomes 5,000 particles per microliter to 15,000 particles per microliter and the shape and distribution of the toner are measured. In the measurement method, it is important to make the dispersion concentration of 5,000 particles per microliter to 15,000 particles per microliter in terms of measurement reproducibility of the average circularity. To obtain the above-mentioned dispersion concentration, the condition of the dispersion, that is, the amount of the surfactant and the toner to be added needs to be changed. The amount of the surfactant varies depending on the hydrophobicity of the toner in the same manner as the above-described measurement of the toner particle diameter. The excess amount of the surfactant generates noise by bubbles, while the less amount of the surfactant fails to adequately wet the toner, and resulted in inadequate dispersion of the toner. The amount of the toner varies depending on the diameter thereof. The toner having a smaller diameter needs less amount thereof, while the toner having a larger diameter needs much amount thereof. When the toner has a diameter of 3 μm to 7 μm, 0.1 g to 0.5 g of the toner is added to adjust the dispersion concentration to 5,000 particles per microliter to 15,000 particles per microliter.

### <Image Forming Apparatus>

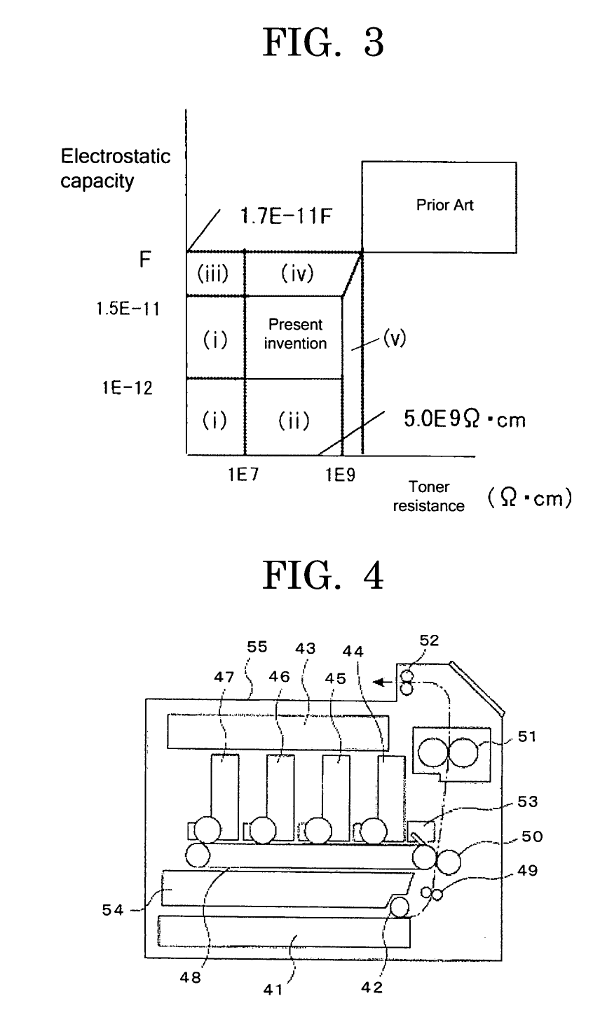

With reference to FIG. 4, an example of an entire configuration of an image forming apparatus of the present invention will be illustrated. An exposing unit 43 optically writes in four image forming units 44, 45, 46, 47 which are substantially horizontally placed side by side to form a latent electrostatic image. Each latent electrostatic image is visualized by the developing unit of each image forming unit.

Each toner image formed on each image forming unit is sequentially transferred so as to be superimposed onto an intermediate transferring belt 48. A transfer paper stacked in a paper cassette 41 is fed by a paper-feeding roller 42, and conveyed to a second transferring unit at a predetermined timing after displacement is corrected by a pair of resist rollers 49. In the second transferring unit, a toner image superimposed on the intermediate transferring belt 48 is transferred on the transfer paper simultaneously by a second transferring roller 50.

Subsequently, a color toner image is fixed as an image on the transfer paper by a fixing unit 51, and ejected as an output image to a paper eject tray 55 on an upper surface of the apparatus by means of a pair of eject rollers 52.

A remaining toner on the intermediate transferring belt 48 after transferring is removed from a belt by means of a cleaning mechanism 53, and accumulated in a waste toner recovery container (waste toner box) 54 serving as a fine particles container (waste toner container).

### <Developing Unit Configuration>

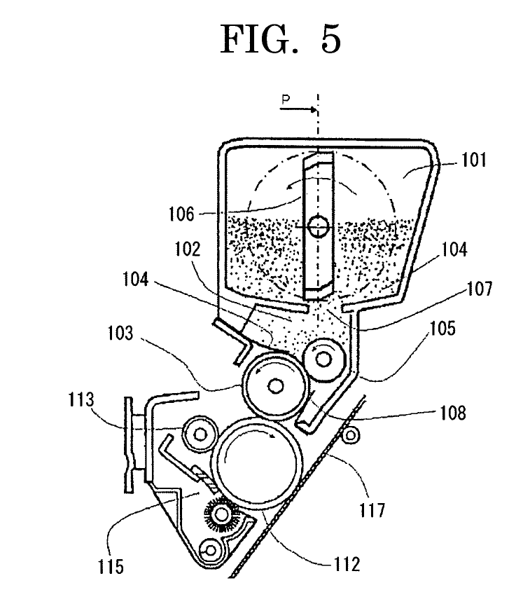

FIG. 5 shows a cross-sectional view of an example of a developing unit and process cartridge unit for an embodiment of the present invention.

The developing unit contains a toner container 101 for containing the toner, a toner supply chamber 102 disposed under the toner container 101. Under the toner supply chamber 102, a developing roller 103, and a layer thickness control unit 104 and a supply roller 105, both of which contact the developing roller 103 are disposed. The developing roller 103 is disposed contacting a photoconductor drum 112 and is applied with a predetermined developing bias by a high-voltage power supply (not shown). In the toner container 101, a toner mixing unit 106 is equipped and configured to rotate in the counterclockwise direction. In an axial direction, a part of an edge of the toner mixing unit 106, which does not pass near an opening, has a larger surface area for feeding the toner by rotation drive so as to sufficiently fluidize and mix the contained toner, while a part of the edge of the toner mixing unit 106, which passes near the opening, has a smaller surface area for feeding the toner by rotation drive so as not to introduce an excess amount of the toner to the opening 107. The toner near the opening 107 is appropriately loosen by means of the toner mixing unit 106, passes through the opening 107 and drops to the toner supply chamber 102 by its own weight. By coating a foamed material having pores (cell) on the surface of the supply roller 105, the toner fed into the toner supply chamber 102 is effectively attached and incorporated thereto, and the toner degradation by pressure concentration at a contact portion with the developing roller 103 is prevented. The electric resistance value of the foamed material is set at 10³Ω to 10¹⁴Ω. A supply bias of the value which is offset in the same direction as the charged polarity of the toner corresponding to developing bias is applied to the supply roller 105. The supply bias affects in the direction of pressing the toner, which is precharged at the contact portion between the supply roller 105 and the developing roller 103, to the developing roller 103. However, the offset direction is not limited thereto, offset may be 0, or the offset direction may be changed depending on the types of the toner. The supply roller 105 rotates in the counterclockwise direction so as to supply the toner adhered on the surface thereof to the surface of the developing roller 103 to thereby be coated thereon. A roller coated with an elastic rubber layer is used as the developing roller 103, and a surface coat layer made of a material which is likely to be charged opposite to the polarity of the toner is further disposed on the surface of the developing roller 103. The elastic rubber layer is designed to have a hardness JIS-A of 50 degrees or less in order to keep the uniform contact with the photoconductor drum 112. Additionally, the electric resistance value of the elastic rubber layer is set at 10³Ω to 10¹⁰Ω in order to effect a developing bias. The surface roughness of the developing roller is set at Ra of 0.2 μm to 2.0 μm so that the required amount of the toner can be retained on the surface thereof. The developing roller 103 rotates in a counterclockwise direction and feeds the toner retained on the surface thereof to positions facing the toner layer thickness control unit 104 and the photoconductor drum 112. The toner layer thickness control unit 104 is formed of a metallic plate spring material, such as SUS304CSP, SUS301CSP and phosphor bronze, and a free end of the toner layer thickness control unit 104 is brought into contact with the surface of the developing roller 103 at a suppress strength of 10 N/m to 100 N/m. The toner passed through the suppressed spot of the toner layer thickness control unit is made in a form of thin layer and is charged by frictional charging, simultaneously. Moreover, a control bias of the value which is offset in the same direction as the charged polarity of the toner corresponding to a developing bias is applied to the toner layer thickness control unit 104 to assist frictional charging. The photoconductor drum 112 rotates in a clockwise direction, therefore, the surface of the developing roller 103 moves in the same direction as the moving direction of the photoconductor drum 112 at the facing position with the photoconductor drum 112. The toner formed in the thin layer is fed to the facing position between the developing roller 103 and the photoconductor drum 112 by the rotation of the developing roller 103, and is moved to the surface of the photoconductor drum 112 and developed according to the latent image electric field formed by the developing bias applied to the developing roller 103 and a latent electrostatic image on the photoconductor drum 112. A seal 108 is provided contacting the developing roller 103 at the part where the toner, which has not been spent for development on the photoconductor drum 112 and remains on the developing roller 103, returns to the toner supply chamber 102 so as to seal the developing unit, and thereby prevents the toner form leaking out thereof.

The material of the elastic rubber layer consisting of the surface of the developing roller is not particularly limited, and may be appropriately selected according to the purpose. Examples thereof include styrene-butadiene copolymer rubber, acrylonitrile-butadiene copolymer rubber, acrylic rubber, epichlorohydrin rubber, urethane rubber, and silicone rubber. These may be used alone or in combination. Among these, a blend rubber of epichlorohydrin rubber and acrylonitrile-butadiene copolymer rubber is preferably used.

The developing roller is, for example, manufactured by coating a periphery of conductive shaft with the above-mentioned elastic rubber material. The conductive shaft is, for example, composed of metal such as stainless steel.

### <Structure of Charging Unit for Latent Electrostatic Image Bearing Member>

The charging unit contains a shaft, a conductive layer disposed on the shaft and a surface layer which covers the conductive layer and is totally formed in a cylindrical shape. The voltage applied to the shaft by a power supply is applied to a latent electrostatic image bearing member through the conductive layer and the surface layer so as to charge a surface of the latent electrostatic image bearing member.

The shaft of the charging unit is disposed along the longitudinal direction of the latent electrostatic image bearing member (in parallel with the axis of the latent electrostatic image bearing member) and the charging unit is entirely pressed against the latent electrostatic image bearing member with a predetermined suppress strength, thereby, a portion of the surface of the latent electrostatic image bearing member and a portion of the surface of the charging unit are brought into contact with each other along each longitudinal direction to form a contact nip with a predetermined width. The latent electrostatic image bearing member is rotary driven by an driving unit and the charging unit is configured so as to rotate along with the latent electrostatic image bearing member.

The charging of the latent electrostatic image bearing member by a voltage source is performed at the vicinity of the above contact nip. The surface of the charging unit and a region to be charged (corresponds to the length of the charging unit) of the surface of the latent electrostatic image bearing member are brought into evenly contact with each other at the contact nip to thereby make the region to be charged of the surface of the latent electrostatic image bearing member uniformly charged.

The conductive layer of the charging unit is formed of a nonmetal, and a material of low hardness can be preferably used in order to stabilize the contact state with the latent electrostatic image bearing member. Examples thereof include resins such as polyurethane, polyether and polyvinyl alcohol and rubbers such as hydrin rubber, EPDM and NBR. Examples of conductive materials include carbon black, graphite, titanic oxide and zinc oxide.

The materials having a moderate resistance value (10²Ω to 10¹⁰Ω) are used for the surface layer.

Examples of resins include nylon, polyamide, polyimide, polyurethane, polyester, silicone, Tefron™, polyacetylene, polypyrrole, polythiophene, polycarbonate and polyvinyl, and fluorine-based resins are preferably used for improving a water contact angle.

Examples of fluorine-based resins include polyvinylidene-fluoride, polyethylene-fluoride, vinylidene fluoride-tetrafluoroethylene copolymer and vinylidene fluoride-tetrafluoroethylene-propylene hexafluoride copolymer.

Furthermore, conductive materials such as carbon black, graphite, titanic oxide, zinc oxide, tin oxide and iron oxide may be appropriately added on the surface layer for the purpose of adjusting the resistance to moderate value.

### EXAMPLES

Hereinafter, with referring to Examples and Comparative Examples, the invention is explained in detail and the following Examples and Comparative Examples should not be construed as limiting the scope of the invention. In Examples and Comparative Examples, all part(s) and percentage (%) are expressed by mass-basis unless indicated otherwise.

### <Preparation of First Binder Resin>

As a vinyl based monomer, 600 g of styrene, 110 g of butyl acrylate, 30 g of acrylic acid and 30 g of dicumyl peroxide as a polymerization initiator were placed in a dropping funnel. In a 5 liter four-necked flask equipped with a thermometer, a stainless stirrer, a falling type condenser and a nitrogen introducing tube, 1230 g of polyoxypropylene (2.2)-2,2-bis(4-hydroxyphenyl)propane, 290 g of polyoxyethylene (2.2)-2,2-bis(4-hydroxyphenyl)propane as polyol among monomers of polyester, 250 g of isododecenyl succinic acid anhydrate, 310 g of terephthalic acid, 180 g of 1,2,4-benzene tricarboxylic acid anhydrate, 7 g of dibutyl tin oxide as an esterification catalyst and 340 g (11.0 parts by mass relative to 100 parts by mass of the monomers) of paraffin wax (melting point of 73.3° C., a half value width of an endothermic peak at temperature rising measured by a differential scanning calorimeter was 4° C.) as wax were placed, and subsequently, under a nitrogen atmosphere in a mantle heater, with stirring at a temperature of 160° C., the mixture of the vinyl-based monomer and the polymerization initiator was dripped from the above dropping funnel over one hour. Then, with keeping at 160° C., an addition polymerization reaction was matured for 2 hours, and subsequently the temperature was raised to 230° C. and a polycondensation reaction was performed. The polymerization degree was traced using the softening point measured using a constant load extrusion capillary rheometer, and when the desired softening point was reached, the reaction was terminated to obtain a first binder resin. The softening point of the resulting resin was 130° C.

### <Preparation of Second Binder Resin>

In a 5 liter four-necked flask equipped with a thermometer, a stainless stirrer, a falling type condenser and a nitrogen introducing tube, 2210 g of polyoxypropylene (2.2)-2,2-bis(4-hydroxyphenyl)propane as polyol, 850 g of terephthalic acid, 120 g of 1,2,4-benzene tricarboxylic acid anhydrate and 0.5 g of dibutyl tin oxide as the esterification catalyst were placed. Then, under the nitrogen atmosphere in the mantle heater, the temperature was raised to 230° C. and the polycondensation reaction was performed. The polymerization degree was traced using the softening point measured using the constant load extrusion capillary rheometer, and when the desired softening point was reached, the reaction was terminated to obtain a second binder resin. The softening point of the resulting resin was 115° C.

### <Preparation of Toner Particles>

To 100 parts by mass (including the mass of the internally added wax) of the binder resin consisting of the first binder resin and the second binder resin, a master batch containing C.I. pigment Red 57-1 corresponding to 4 parts by mass was mixed using a HENSCHEL mixer, and subsequently melted and kneaded using a biaxial extrusion kneader (PCM-30 manufactured by Ikegai Tekkosho). A resulting kneaded product was pressed and extended to a thickness of 2 mm using a cooled press roller, cooled with a cooling belt, and subsequently roughly pulverized using a feather mill. Subsequently, a roughly-pulverized product was pulverized using a mechanical pulverizer (KTM manufactured by Kawasaki Heavy Industries, Ltd.) to have an average particle diameter of 10 μm to 12 μm, and further pulverized using a jet pulverizer (IDS manufactured by Nippon Pneumatic MFG. Co., Ltd.) with roughly classifying and subsequently classifying fine particles using a rotor type classifying machine (deep lex type classifying machine 100ATP manufactured by Hosokawa Micron Ltd.) to obtain colored resin particles. The resulting colored resin particles had an average particle diameter of 7.8 μm.

A certain amount of a metal oxide was added to 100 parts by mass of the colored resin particles to fix thereon by the above-mentioned mechanofusion system. Then, the inorganic fine particles were added by the amount (parts by mass) shown in Table 1, and mixed by a HENSCHEL mixer to obtain toner base particles (magenta toner particles).

### Examples 1 to 4

### Comparative Examples 1 to 7

Fine particles shown in Table 1 were fixed on the resulting toner base particles under the following condition, and then a certain amount of the following silica was externally added to obtain toner particles.

One part by mass of H2000/4 by Clariant, and 2.0 parts by mass of NX90 by NIPPON AEROSIL Co., Ltd. relative to 100 parts by mass of the toner base particles were treated with a HENSCHEL mixer at a circumferential velocity of 35 m/s for 15 minutes.

### Evaluation

### <Toner Particle Diameter>

The method for measuring particle size distribution of the toner particles will be explained. Examples of measuring devices for the particle size distribution of toner particles by a Coulter counter method include Coulter counter TA-II and Coulter multisizer II (both manufactured by Beckman Coulter, Inc.).

The method for measuring the particle size distribution is described hereinafter. First, 0.1 ml to 5 ml of a surfactant (preferably alkylbenzene sulfonate) was added to 100 ml to 150 ml of electrolytic solution as a dispersant. The electrolytic solution was an approximately 1 mass % aqueous solution of NaCl prepared using primary sodium chloride (ISOTON-II manufactured by Beckman Coulter, Inc). 2 mg to 20 mg of the measurement sample was further added in terms of a solid content. The electrolytic solution in which the sample was suspended was subject to dispersion treatment for approximately 1 minute to 3 minutes using an ultrasonic disperser and the volume and number of the toner particles or the toner were measured by means of the measuring equipment, employing an aperture of 100 μm to calculate volume and number distributions. The volume average particle diameter (Dv) and number average particle diameter (Dp) of the toner were obtained from the resulting distributions.

As channels, 13 channels were used: 2.00 μm to less than 2.52 μm; 2.52 μm to less than 3.17 μm; 3.17 μm to less than 4.00 μm; 4.00 μm to less than 5.04 μm; 5.04 μm to less than 6.35 μm; 6.35 μm to less than 8.00 μm; 8.00 μm to less than 10.08 μm; 10.08 μm to less than 12.70 μm; 12.70 μm to less than 16.00 μm; 16.00 μm to less than 20.20 μm; 20.20 μm to less than 25.40 μm; 25.40 μm to less than 32.00 μm; 32.00 μm to less than 40.30 μm. The particles having a particle diameter of 2.00 μm or more to less than 40.30 μm were surveyed.

### <Evaluation of Electric Property>

Three gram of the toner was charged in a molding machine, and a force of 7.5N was applied for 30 seconds to produce a pellet of 40 ømm. An impedance response of the pellet was measured in a frequency range of 10 Hz to 10,000 Hz by application of 0.1 V voltage across the pellet with electrodes attached to both ends to obtain an electrostatic capacity and resistance.

### <Adhesion Strength>

A surfactant and the toner were added in water, treated by an ultrasonic homogenizer at 40 W for 1 minute, and then the toner was separated and dried. The ratio of the adhesion amount between before and after the treatment was obtained by means of a fluorescent X-ray analyzer.

TABLE 1

| | Fixed fine particles | | | | | | | | | |
|---|---|---|---|---|---|---|---|---|---|---|
| | | | | Content | | | Toner property | | | |
| | | | Particle | (Amunt | Condition of Ong mill | | Adhesion | | Electrostatic | Average |
| | | | diameter | to be | Fixing | | strength | Resistance | capacity | circularity |
| | Types of fine particles | | (am) | added) | temperature | Time | (%) | (Ω · cm) | (F) | of toner |
| Example 1 | Titanium oxide | STT30S | 30 | 1.5 | 55 | 10 | 98 | 2.1E + 08 | 6.1E − 12 | 0.924 |
| Example 2 | Titanium oxide | STT30S | 30 | 1.9 | 55 | 10 | 97 | 1.1E + 07 | 1.0E − 12 | 0.922 |
| Example 3 | Titanium oxide | STT30S | 30 | 1.1 | 54 | 10 | 95 | 9.9E + 08 | 1.5E − 11 | 0.918 |
| Example 4 | Titanium oxide | STT65C | 50 | 1.5 | 56 | 10 | 98 | 1.9E + 08 | 5.9E − 12 | 0.927 |
| Comparative | Titanium oxide | STT30S | 30 | 0.9 | 56 | 10 | 99 | 1.5E + 09 | 1.8E − 11 | 0.934 |
| Example 1 | | | | | | | | | | |
| Comparative | Titanium oxide | STT30S | 30 | 2.2 | 56 | 10 | 97 | 8.8E + 06 | 3.7E − 12 | 0.931 |
| Example 2 | | | | | | | | | | |
| Comparative | Titanium oxide | STT30S | 30 | 1.5 | 62 | 12 | 100 | 1.1E + 10 | 3.5E − 11 | 0.946 |
| Example 3 | | | | | | | | | | |
| Comparative | Titanium oxide | STT30S | 30 | 1.5 | 55 | 5 | 93 | 5.8E + 09 | 2.3E − 11 | 0.910 |
| Example 4 | | | | | | | | | | |
| Comparative | Titanium oxide | STT30S | 30 | 0 | 54 | 10 | 0 | 2.2E + 10 | 3.9E − 11 | 0.919 |
| Example 5 | | | | | | | | | | |
| Comparative | Titanium oxide | ST550J | 70 | 1.5 | 56 | 10 | 96 | 8.7E + 06 | 1.4E − 12 | 0.931 |
| Example 6 | | | | | | | | | | |
| Comparative | Strontium | SW360 | 100 | 1.5 | 56 | 10 | 97 | 3.6E + 06 | 1.9E − 12 | 0.930 |
| Example 7 | titanate | | | | | | | | | |

In Table 1, “STT30S”, “STT30C”, ST550J”, and “SW360” are trade names of titanium manufactured by Titan Kogyo, Ltd. The last one, “SW-100” is a strontium titanate manufactured by Titan Kogyo, Ltd.

The average circularity (shape factor) of the toner particles in each Example are as shown in Table 1. The toner had a shape factor of 0.905 before treatment. The circularity was improved by processing this toner.

The average circularity (shape factor) was measured in an optical detection area. Specifically, a suspension containing the toner was passed though imaging and detecting area on a flat plate to optically detect a particle image by a CCD camera, and analyzed. In the present invention, the average circularity could be measured by a flow type particle image analyzer FPIA-2100 (by Sysmex Corporation). The “circularity” is represented by a value obtained by dividing the circumferential length of a circle which has the same area as a projected area of a toner particle by the circumferential length of the toner particle.

The procedures to bring out these distinct results are considered as follows: a key point is to cause the fixed fine particles to have a certain degree of diameter and resistance. When the fixed fine particles are too large, the resistance and electrostatic capacity of the toner may be difficult to be adjusted to an optimal range only by the method of fixing fine particles. In particular, the resistance may be largely decreased. The resistance of the fine particles may largely affect to the resistance value of the toner. It is important that the certain amount of the fine particles having a certain degree of diameter and resistance (neither high resistance nor low resistance) be firmly fixed on the surface of the toner base. Neither excess nor less amount of the fine particles reaches an optimal area of the electric property.

For production conditions, the temperature should be adjusted to promote fixation on the toner. Generally, the elasticity of the binder resin is lowered at a temperature of approximately 10° C. lower than Tg of the binder resin of the toner, so that fine particles are easily fixed on the toner. Under the condition, a desired fixation degree can be obtained by subjecting to be treated for an optimal time (optimal stress). A longer treatment time promotes embedding of the fine particles in the toner, while a shorter treatment time does not promote fixation of fine particles on the toner. The same is true in temperature; a lower temperature does not promote fixation of fine particles on the toner, while a higher temperature promotes embedding of fine particles in the toner at once. The Ong mill is a device for surface modification and needs to be finely conditioned. When the condition is changed, the toner surface is drastically modified, that is, it is necessary to perform the surface modification in a small range.

### Image Evaluation

Images were evaluated by using a color laser printer IPSiO CX3000 manufactured by Ricoh Company, Ltd. Evaluation items and evaluation criteria are illustrated below, and results are shown in Table 2. An external power was used to apply a certain voltage. Potential differences between the developing bias and the controlling blade are shown in Table 2. The developing bias was a negative bias, and the controlling blade was applied with a negative bias.

### <Background Smear>

The amount of toner adhesion on a blank image was evaluated.

A: No adhesion

B: Toner adhesion on an image, but not considered to be a problem.

C: Toner adhesion on an image leading to a quality problem.

<Roughness after Transferred>

Uneven concentration in a half tone image was evaluated by visual observation.

A: No uneven concentration

B: Uneven concentration in an image, but not considered to be a problem.

C: Uneven concentration in an image leading to a quality problem.

### <Reduction of Charge Amount>

The variation of the charge amount by durability was evaluated.

The variation range of the charge amount from the beginning was evaluated as follows:

A: 5 μC/g or less

B: 5 μC/g to 10 μC/g

C: 10 μC/g or more

TABLE 2

| | Potential | Background | | Reduction of |
|---|---|---|---|---|
| Toner | difference | smear | Roughness | charge amount |
| Example 1 | 100 | A | A | A |
| Example 1 | 60 | B | A | A |
| Example 1 | 170 | A | A | A |
| Example 2 | 100 | B | A | A |
| Example 3 | 100 | A | B | A |
| Example 4 | 100 | A | A | A |
| Comparative | 100 | C | C | C |
| Example 1 | | | | |
| Comparative | 100 | C | A | A |
| Example 2 | | | | |
| Comparative | 100 | C | C | C |
| Example 3 | | | | |
| Comparative | 100 | C | C | C |
| Example 4 | | | | |
| Comparative | 100 | C | C | C |
| Example 5 | | | | |
| Comparative | 100 | C | A | A |
| Example 6 | | | | |
| Comparative | 100 | C | A | A |
| Example 7 | | | | |
| Example 1 | 30 | C | A | A |
| Example 1 | 230 | A | A | C |

What is claimed is:

1. A nonmagnetic one-component toner comprising:
a colorant, and
a binder resin,
wherein metal oxide fine particles are fixed on a toner surface with an adhesion strength of 95% to 99%, the toner has a direct current resistance of 1E7 Ω·cm to 1E9 Ω·cm, and an electrostatic capacity of 1.0E-12F to 1.5E-11F.

2. The nonmagnetic one-component toner according to claim 1, wherein the metal oxide fine particles have a specific resistance of 1.0E7 Ω·cm to 5.0E9 Ω·cm.

3. The nonmagnetic one-component toner according to claim 1, wherein the metal oxide fine particles fixed on the toner surface are titanium oxide, and the metal oxide fine particles have dispersion diameter of 10 nm to 50 nm, and the content of the metal oxide fine particles is 1.0% by mass to 2.0% by mass based on the toner mass.

4. The nonmagnetic one-component toner according to claim 1, wherein the toner has a volume average particle diameter of 6 μm to 10 μm.

5. The nonmagnetic one-component toner according to claim 1, wherein the toner has an average circularity of 0.900 to 0.930.

6. An image forming apparatus comprising:
a plurality of developing units configured to form a color image by using black and color nonmagnetic toners,
wherein the developing unit comprises a controlling blade applied with a negative bias with respect to a developing roller,
wherein the toner is a nonmagnetic one-component toner comprising:
a colorant, and
a binder resin,
wherein metal oxide fine particles are fixed on a toner surface with an adhesion strength of 95% to 99%, the toner has a direct current resistance of 1E7 Ω·cm to 1E9 Ω·cm, and an electrostatic capacity of 1.0E-12F to 1.5E-11F.

7. The image forming apparatus according to claim 6, wherein an absolute value of the potential difference between the developing roller and the controlling blade is 50 V to 200 V.

8. The image forming apparatus according to claim 6, further comprising a fixing unit configured to fix a toner image to a recording medium by oilless fixing, wherein the content of a releasing agent in the toner is 3.0% by mass to 5.0% by mass.

9. A process cartridge comprising:
a latent electrostatic image bearing member configured to bear a latent electrostatic image,
a developing unit configured to develop the latent electrostatic image borne on the latent electrostatic image bearing member by using a toner so as to form a visible image, and comprises a controlling blade applied with a negative bias with respect to a developing roller,
wherein the process cartridge is mounted to an image forming apparatus, and the image forming apparatus comprises:
a plurality of the developing units configured to form a color image by using black and color nonmagnetic toners,
wherein the toner is a nonmagnetic one-component toner comprising:
a colorant, and
a binder resin,
wherein metal oxide fine particles are fixed on a toner surface with an adhesion strength of 95% to 99%, the toner has a direct current resistance of 1E7 Ω·cm to 1E9 Ω·cm, and an electrostatic capacity of 1.0E-12F to 1.5E-11F.

10. An image forming method comprising:
forming a color image by using a plurality of developing units containing black and color nonmagnetic toners,
wherein the developing unit comprises a controlling blade applied with a negative bias with respect to a developing roller,
wherein the toner is a nonmagnetic one-component toner comprising:
a colorant, and
a binder resin,
wherein metal oxide fine particles are fixed on a toner surface with an adhesion strength of 95% to 99%, and the toner has a direct current resistance of 1E7 Ω·cm to 1E9 Ω·cm, and an electrostatic capacity of 1.0E-12F to 1.5E-11F.

11. The image forming method according to claim 10, wherein an absolute value of the potential difference between the developing roller and the controlling blade is 50 V to 200 V.

12. The image forming method according to claim 10, further comprising fixing a toner image to a recording medium by oilless fixing, wherein the content of a releasing agent in the toner is 3.0% by mass to 5.0% by mass.
